(19) United States
(12) Patent Application Publication
(10) Pub. No.: US 2003/0119945 A1
(43) Pub. Date: Jun. 26, 2003

(54) Road marking aqueous coating composition

(76) Inventor: Kazuhiko Aibara, Saitama (JP)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/238,309

(22) Filed: Sep. 10, 2002

(30) Foreign Application Priority Data
Sep. 11, 2001 (JP) 273309/2001

(51) Int. Cl. C08K 3/32; F21V 7/22

(52) U.S. Cl. 523/172; 524/414

(57) ABSTRACT

An aqueous based coating composition for road marking, having fast-drying and improved resistance to yellowing properties, is disclosed. The composition contains a binder polymer and at least one pigment selected from zinc phosphate and calcium zinc phosphate.

### DETAILED DESCRIPTION OF THE INVENTION

The present invention relates to a road marking aqueous coating composition. More particularly, the present invention relates to a road marking aqueous coating composition having fast-drying property and an improved yellowing property.

One of the many important features of coatings in general, and road markings or traffic paints in particular, is the speed at which they dry on the surface of a particular substrate after application. For instance, the drying speed of a traffic paint dictates the length of the period of disruption to road traffic during application of the paint to road surfaces, and subsequent drying. The trend is to demand shorter and shorter disruptions of traffic flow, meeting this demand by using fast-drying paint. Used herein, the terms “coating” and “paint” will be used interchangeably and referred to as a general class including traffic paints and road markings. In addition, the terms “traffic paint” and “road marking” are used interchangeably herein.

Solvent-based fast-drying coatings are based on organic polymeric resins (also frequently called binders) dissolved, suspended or otherwise dispersed in relatively low boiling organic solvents. Low-boiling volatile organic solvents evaporate rapidly after application of the paint on the road to provide the desired fast-drying characteristics of a freshly applied road marking. However, in addition to releasing volatile organic solvents into the environment, spreading of the paint formulation tends to expose the workers to the vapors of the organic solvents. Because of these shortcomings and increasingly stringent environmental mandates from governments and communities, it is highly desirable to develop more environmentally friendly coatings or paints while retaining fast-drying properties and/or characteristics.

More environmentally friendly coating use water based, i.e., waterborne, rather than solvent based polymers or resins. Coating formulations, both solvent based and waterborne, include binder polymers. The term binder polymer used herein refers to polymers that are included in the coating composition and that augment or participate in film formation and in the composition of the resultant film.

Primarily due to a combination of high boiling point, high latent heat of vaporization, high polarity, and strong hydrogen bonding of water, drying times of waterborne paints or coatings are generally longer than those exhibited by the organic solvent based coatings. The drying time strongly depends on the relative humidity of the atmosphere in which the coatings are applied. A waterborne paint may take several hours or more to dry in high humidity. The problem of retarded drying rate is especially aggravated for thick film (greater than about 500 μ) traffic markings. Long drying times severely limit the desirability of using water borne paints, particularly traffic paints and road marking paints because of longer traffic disruptions.

Much research has been devoted to ensuring that white water-borne traffic paints remain white and stain free for as long as possible after application. However, it has been observed that portions of clean white surfaces of newly applied traffic paint can turn to a dirty yellow or brown color, sometimes along long stretches of traffic markings on the road. Such a staining phenomenon is known as “yellowing”. Although the visibility of the paint is normally not seriously affected, the yellowing is undesirable for aesthetic reasons, and particularly because users of the traffic paint may believe that a paint which turns yellow within days of application is of poor quality.

Until now there has been no explanation for this phenomenon, which is noted for the apparent randomness of its appearance, and the fact that it occurs soon after application or not at all. An identical paint applied on the same stretch of road on two occasions may turn yellow at one time, and not the next. As a result of this lack of understanding of the problem, a solution has so far not been found.

We have now established a possible cause for this phenomenon, and as a result have been able to unexpectedly develop a solution. We believe that the yellowing is caused by iron reacting with materials in the paint formulation to produce what is essentially rust inside the paint, thereby causing yellowing. There is no obvious source of iron in the vicinity of an applied traffic paint. It is believed that it may come from vehicles or even from some components of the road surfaces, such as, asphalt, on which the paint has been applied. The iron may be able to penetrate the paint if there is high humidity or rain in the first 24 to 48 hours after application, when the paint is not fully dry and hence is still susceptible to water penetration. Having been introduced into the paint layer in this way, water then is believed to react with certain components of the paint to form a yellow or brown “rust”, which stains the paint and causes yellowing. However, if the rain is particularly heavy, the iron and “rust” may be washed out, thereby removing the yellow color. This would, without reliance thereon, explain the apparent randomness of the phenomenon.

EP-A-34383 I discloses a top coat paint for protecting a surface from external rust staining, i.e., rust from an external source that drips or falls onto the surface. The paint contains a chelating agent capable of reacting with iron ions in rust to form a colorless complex. GB 2172599A discloses a similar paint, which contains as chelating agent, which is a polyphosphonate salt pigment. Neither of these references, nor any of the other prior disclosures of such anti-rust staining paints, mention such a problem with traffic paints.

Japanese Patent Publication No.118840/1997 discloses a paint comprising a chelating agent capable of chelating iron ions. However, this patent application does not disclose to use a particular pigment.

The present invention provides a aqueous coating composition comprising a binder polymer and at least one pigment selected from the group consisting of zinc phosphate and calcium zinc phosphate. Another aspect of the present invention provides a road marking aqueous coating composition comprising a binder polymer and at least one pigment selected from the group consisting of zinc phosphate and calcium zinc phosphate.

The present invention further provides a coating layer obtained by drying the above composition. The present invention further provides a method for forming a road marking comprising to apply the above aqueous coating composition to a surface of road.

The present invention provides fast-drying aqueous coating composition that has an excellent stability and can reduce or eliminate yellowing. More particularly, the present invention provides fast-drying road marking aqueous coating composition that has an excellent stability and can reduce or eliminate yellowing of newly applied road marking.

The present invention can be used in many coating, painting or marking applications. For instance, the method and composition of the present invention can be used for traffic paints, road markings, house paints, maintenance coatings for exterior or interior surfaces of buildings, walls, roofs, and other structures. The surface of the substrate may be wood, metal (such as aluminum, steel and others) polymers, plaster and others. Other applications include coating metal substrates present in a wide variety of manufactured articles such as signs, boats, cars, etc. All of the substrates may already have one or more layers of existing coating or paint which may be fresh or aged.

The coating composition of the present invention is suitable as a road marking aqueous coating composition and generally applied on a surface of road.

The term “road” is used herein as a generic term and it includes any indoor or outdoor solid surface that is or may be exposed to pedestrians, moving vehicles, tractors, or aircraft continuously, constantly or intermittently. Some non-limiting examples of a “road” include highways, streets, driveways, sidewalks, runways, taxiing areas, tarmac areas, parking lots, rooftops, indoor floors (such as factory floors, inside a shopping mall, etc), and others. The surface material may be masonry, tar, asphalt, resins, concrete, cement, stone, stucco, tiles, wood, polymeric materials and combinations thereof. It is also within the scope of the invention to apply such a two- or multi-component water borne coating over another one or more layers of fresh or aged coating or marking already applied on the surface.

The term “fast-drying” means that the drying time of the coating composition is shorter than that of the coating composition that differs merely in an absence of zinc phosphate and calcium zinc phosphate.

The binder polymer of the present invention may have any composition and any molecular weight. The specific method by which a binder polymer is prepared is not particular importance to the present invention. Binder polymer may be prepared via bulk and solution polymerization, and by aqueous dispersion, suspension and emulsion polymerization, or any other method that would produce the desired polymer soluble, partially soluble, or dispersed in water or a mixture of water and a water-miscible solvent, or capable of being dissolved, partially dissolved, or dispersed in water or a mixture of water and a water-miscible solvent.

A preferred method for preparing the binder polymer is aqueous emulsion polymerization. Polymers thus prepared are usually stabilized by adding anionic, nonionic, or cationic surfactants, or by the incorporation of anionic or cationic moieties into the polymer itself during synthesis. The emulsion polymerization can be carried out by a number processes such as those descried in Blackley, D. C. Emulsion Polymerization; Applied Science Publishers: London, 1975; Odian, G. Principles of Polymerization; John Wiley & Sons: New York, 1991; Emulsion Polymerization of Acrylic Monomers; Rohm and Haas, 1967.

“Dispersed binder polymer” means a stabilized colloidal dispersion of binder polymer particles in an aqueous carrier.

“Solubilized binder polymer” means water-soluble binder polymer dissolved in an aqueous carrier.

“Binder polymer solid” means the binder polymer in its dry state.

“Pigment dispersant” means a material used for improving the dispersion of pigment particles in a paint composition. The pigment dispersant is believed to adsorb on the surface of pigment particles in a paint composition to increase the negative charge thereon. As a result, it is believed that the columbic repulsion between pigment particles is increased and the dispersion of pigment particles in the paint composition is thereby improved.

Preferably, the dispersed or solubilized binder polymer can, for example, be prepared from a wide range of acrylic and methacrylic monomers, including C₁-C₁₈ (meth)acrylate esters, such as, methyl (meth)acrylate, ethyl(meth)acrylate, isomers of propyl(meth)acrylate, isomers of butyl(meth)acrylate, 2-etylhexyl (meth)acrylate, isobornyl (meth)acrylate, isodecyl(meth) acrylate, oleyl(meth)acrylate, palmityl (meth)acrylate, stearyl(meth)acrylate, 2-hydroxyethyl (meth)acrylate, 3-hydroxypropyl(meth)acrylate, 4-hydroxybutyl(meth)acrylate, glycidyl(meth)acrylate; acrylamide or substituted acrylamides; (meth)acrylonitril; diacetone acrylamide; acetoacetylethyl methacrylate; acrolein and methacrolein; dicyclopentadienyl methacrylate; dimethyl meta-isopropenylbenzyl isocyanate; isocyanatoethyl methacrylate; styrene or substituted styrenes; butadiene; ethylene; vinyl acetate or other vinyl esters; vinyl monomers, such as, for example, vinyl halide, preferably vinyl chloride, vinylidene halide, preferably vinylidene chloride, N-vinyl pyrrolidone; amino monomers, such as, for example, N,N-dimethylaminoethyl(meth)acrylate, N,N-dimethylaminopropyl methacrylamide, and oxazolidinoethyl methacrylate. Throughout this document, the word fragment “(meth)acryl” refers to both “methacryl” and “acryl”. For example, (meth)acrylic acid refers to both methacrylic acid and acrylic acid, and methyl(meth)acrylate refers to both methyl methacrylate and methyl acrylate.

If desired, the dispersed or stabilized binder polymer further includes in the range of from 0.5% to 20.0%, preferably in the range from 5% to 15%, of a monomer containing an acid functionality, all percentages being in weight percent based on the total weight of binder polymer.

The acid functionality results from including in the monomer mixture one or more of the monoethylenically unsaturated carboxylic acid monomers, such as, for example, acrylic acid, methacrylic acid, itaconic acid, crotonoic acid, aconitic acid, atropic acid, maleic acid, maleic anhydride, fumaric acid, vinyl benzoic acid, half-esters of ethylenically unsaturated dicarboxylic acids, half-amides of ethylenically unsaturated dicarboxylic acids and various mixtures thereof. Other suitable monomer include one or more monomethyl itaconate, monomethyl fumarate, monobutyl fumarate, acrylamido propane sulfonate, sodium vinyl sulfonate, 2 acrylamido-2-methylpropanesulfonic acid, 2-methacryloxyethyl phosphate (MOP) and phosphoethyl(meth)acrylate. The monomer containing the monoethylenically unsaturated carboxylic acid are preferred and acrylic acid, methacrylic acid and mixtures thereof are more preferred.

Optionally, a low level of a multi-ethylenically unsaturated monomer such as, for example, 0-5% by weight based on the weight of the dry polymer of allyl(meth)acrylate, diallyl phthalate, 1,4-butylene glycol di(meth)acrylate, 1,6-hexanediol di(meth)acrylate, and trimethylolpropane tri(methyl)acrylate may be used subject to maintaining a sufficiently low level of crosslinking that, in the case of solution polymers, unmanageable viscosity is not attained, or that, in the case of emulsion polymers, effective film formation is not compromised. The terms “coating”, “film”, and “coating film” are used interchangeably herein, and refer to the film that forms and dries as a layer on the surface of a substrate.

The traffic paint can preferably include polyfunctional amine polymerized from one or more monomers. If desired, the traffic paint can include an amine modified dispersed or stabilized binder polymer, or a blend of the dispersed or stabilized binder polymer with a polyfunctional amine or a combination, preferably in equal proportions, of the blend and the amine modified binder polymer. The blend includes from 0 to 20%, preferably 0.5 to 10, and more preferably 2 to 5%, of the polyfunctional amine, all in weight percentages based on the total weight of the blend solid.

The polyfunctional amine is polymerized from 20 percent to 100 percent, preferably from 50 percent to 100 percent, all in weight percentages based on the total weight of the polyfunctional amine solids of at least one or more classes of the amine containing monomers disclosed below:

Class 1. Aminoalkyl vinyl ethers wherein the alkyl groups may be straight-chain or branched-chain type and have from two to three carbon atoms and wherein the nitrogen atom may be a primary, secondary, or tertiary nitrogen atom. Such a process is disclosed in the U.S. Pat. No. 2,879,178. When one of the remaining hydrogen atoms may be substituted by alkyl, hydroxyalkyl, or alkoxyalkyl groups, the alkyl components of which may have one to four carbon atoms, preferably one carbon atom only. Specific examples include: beta-aminoethyl vinyl ether; beta-aminoethyl vinyl sulfide; N-monomethyl-beta-aminoethyl vinyl ether or sulfide; N-monoethyl-beta-aminoethyl vinyl ether or sulfide; N-monobutyl-beta-aminoethyl vinyl ether or sulfide; and N-monomethyl-3-aminopropyl vinyl ether or sulfide.

Class 2. Acrylamide or acrylic esters, such as those of the formula I:

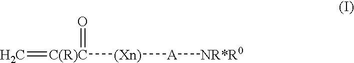

wherein

R is H or CH₃;

n is 0 or 1;

X is O or N(H);

When n is zero, A is O(CH₂).sub.x wherein x is 2 to 3, or (O-alkylene).sub.y wherein (O-alkylene).sub.y is a poly(oxyalkylene) group, having a GPC number average molecular weight in the range from 88 to 348, in which the individual alkylene radicals are the same or different and are either ethylene or propylene; and

when n is 1, A is an alkylene group having two to 4 carbon atoms;

R* is H, methyl, or ethyl; and

R⁰ is H, phenyl, benzyl, methylbenzyl, cyclohexyl, or (C₁-C₆) alkyl.

Some of the preferred Examples of compounds of formula I include: dimethylaminoethylacrylate or methacrylate; beta-aminoethyl acrylate or methacrylate; N-beta-aminoethyl acrylamide or methacrylamide; N-(monomethylaminoethyl)-acrylamide or methacrylamide; N-(mono-n-butyl)-4-aminobutyl acrylate or methacrylate; methacryloxyethoxyethylamine; and acryloxypropoxypropoxypropylamine.

Class 3. N-acryloxyalkyl-oxazolidines and N-acryloxyalkyltetrahydro-1,3-oxazines and the corresponding components in which the “alkyl” linkage is replaced by alkoxyalkyl and poly(alkoxy-alkyl), all of which are embraced by Formula II:

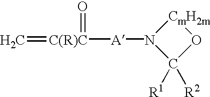

wherein

R is H or CH₃;

m is an integer having a value of 2 to 3;

R′, when not directly joined to R^{2,} is selected from the group consisting of hydrogen, phenyl, benzyl, and (C₁-C₁₂) alkyl groups;

R², when not directly joined to R′, is selected from the group consisting of hydrogen and (C₁-C₄) alkyl groups; R′ and R², when directly joined together, form a 5- to 6-carbon ring with the attached carbon atom of the ring in the formula. i.e., R′ and R², when joined together, are selected from the group consisting of pentamethylene and tetramethylene; and

A′ is O(C.sub.m H₂ₘ)— or (O-alkylene)ₙ in which (O-alkylene)ₙ is a poly(oxyalkylene) group, having a GPC number average molecular weight in the range from 88 to 348, in which the individual alkylene radicals are the same or different and are either ethylene or propylene.

The compounds of Formula II can hydrolyze under various conditions to secondary amines. The hydrolysis produces products having the Formula III:

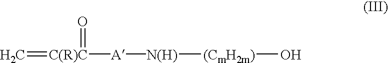

The compounds of Formula III are disclosed in U.S. Pat. Nos. 3,037,006 and 3,502,627. Any of the monomeric compounds therein disclosed may be used in preparing the copolymers to be used for the compositions of the present invention.

Some of the preferred Examples of compounds of Formula III include:

oxazolidinylethyl methacrylate; oxazolidinylethyl acrylate;

3-(gamma-methacryl-oxypropyl)-tetrahydro-1,3-oxazine; 3-(beta-methacryloxyethyl)-2,2-penta-methylene-oxazolidine;

3-(beta-methacryloxyethyl-2-methyl-2-propyloxazolidine;

N-2-(2-acryloxyethoxy)ethyl-oxazolidine;

N-2-(2-methacryloxyethoxy)ethyloxazolidine;

N-2-(2-methacryloxyethoxy)ethyl-5-methyl-oxazolidine;

N-2-(2-acryloxycthoxy)ethyl-5-methyl-oxazolidine;

3->2-(2-methacryloxyethoxy)ethyl)-2,2-penta-methylene-oxazolidine;

3->2-(2-methacryloxyethoxy)ethyl)-2,2-dimethyloxazolidine;

3->2-(methacryloxyethoxy)ethyl-2-phenyl-oxazolidine;

2-isopropenyl-2-oxazoline.

Class 4. Polymers of monomers which readily generate amines by hydrolysis are useful in the preparation of the polyfunctional amine. Examples of such monomers are acryloxy-ketimines and acryloxy-aldimines, such as those of Formulas IV and V following:

H₂C═(CR)—COOA″N═Q (IV)

H₂C═C(R)—CO—(D)_{n″-1}—(B)_{n′-1}—(A⁰)n⁰₋₁—N═Q (V)

wherein

R is H or CH₃;

Q is selected from the group consisting of

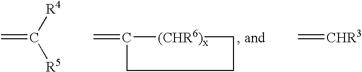

R⁶ is H or it may be methyl in one CHR⁶ unit; R⁵ is selected from the group consisting of (C₁-C₁₂)-alkyl and cyclohexyl groups;

R⁴ is selected from the group consisting of (C₁-C₁₂)-alkyl and cyclohexyl

R³ is selected from the group consisting of phenyl, halophenyl.

(C₁-C₁₂)-alkyl, cyclohexyl, and (C₁-C₄)alkoxyphenyl groups;

A″ is an alkylene group (C₁-C₁₂;

A⁰, B and D arc the same or different oxyalkylene groups having the formula —OCH(R⁷)—CH(R⁷)— wherein R⁷ is H, CH₃, or C₂ H₅;

x is an integer having a value of 4 to 5;

n⁰ is an integer having a value of 1 to 200;

n′ is an integer having a value of 1 to 200; and

n″ is an integer having a value of 1 to 200, the sum of n⁰−1, n′−1 and n″−1 has a value of 2 to 200.

Some of the preferred examples of compounds of formulas IV and V include:

2->4-(2,6-dimethylheptylidene)-amino-ethyl methacrylate;

3->2-(4-methylpentylidine)-amino-propyl methacrylate;

beta-(benzylideneamino)-ethyl methacrylate;

3->2-(4-methylpentylidine)-amino-ethyl methacrylate;

2->4-(2,6-dimethylheptylidene)-amino-ethyl acrylate;

12-(cyclopentylidene-amino)-dodecyl methacrylate;

N-(1,3-dimethylbutylidene)-2-(2-methacryloxyethoxy)-ethylamine;

N-(benzylidene)-methacryloxyethoxyethylamine;

N-(1,3-dimethylbutylidene)-2-(2-acryloxyethoxy)-ethylamine; and

N-(benzylidene)-2-(2-acryloxyethoxy)ethylamine.

The compounds of Formulas IV and V hydrolyze in acid, neutral, or alkaline aqueous media to produce the corresponding primary amines or salts thereof in which the group —N.dbd.Q of the formulas becomes —NH₂ and O═Q. The compounds of Formulas IV and V are disclosed in U.S. Pat. Nos. 3,037,969 and 3,497,485, and any of the monomeric compounds therein disclosed may be used in the making of the copolymers to be used in the water-soluble polymer portion of the compositions of the present invention.

Binder polymers of the present invention typically have glass transition temperature Tg values in the range −10 C. to 70 C., because those having Tg values below −10 C. tend to have poor resistance to dirt pick-up and those having Tg values above 70 C. usually display diminished ability to form films. In certain applications, however, the lower limit for Tg can be even lower than −10 C. For example, the binder polymers used in roof coatings can have Tg's as low as −40 C. The Tg of a polymer is the temperature at which a polymer transitions from a rigid, glassy state exiting at temperatures below the Tg to a fluid or rubbery state exiting at temperatures above Tg. The Tg of a polymer is typically measured by differential scanning calorimetry (DSC) using the mid-point in the heat flow versus temperature transition as the Tg value. A typical heating rate for the DSC measurement is 20 C. per minute.

Initiation of emulsion polymerization may be carried out by the thermal decomposition of free radical precursors, also called initiators herein, which are capable of generating radicals suitable for initiating addition polymerization. Suitable thermal initiators such as, for example, inorganic hydroperoxides, inorganic peroxides, organic hydroperoxides, and organic peroxides, are useful at levels of from 0.05 percent to 5.0 percent by weight, based on the weight of monomers. Free radical initiators known in the art of aqueous emulsion polymerization include water-soluble free radical initiators, such as hydrogen peroxide, tert-butyl peroxide; alkali metal (sodium, potassium or lithium) or ammonium persulfate; or mixtures thereof. Such initiators may also be combined with reducing agents to form a redox system. Useful reducing agents include sulfites such as alkali metal meta bisulfite, or hyposulfite, sodium thiosulfate, or sodium formaldehyde sulfoxylate. The free radical precursor an reducing agent together, referred to as a redox system herein, may be used at a level of from about 0.01% to 5%, based on the weight of monomers used. Examples of redox systems include t-butyl hydroperoxide/sodium formaldehyde sulfoxylate/Fe(II) and ammonium persulfate/sodium bisulfite/sodium hydrosulfite/Fe(II). The polymerization temperature may be 10 C. to 110 C., depending upon such things as free radical initiator decomposition constant and reaction vessel pressure capabilities.

Chain transfer agents may be used in an amount effective to provide the desired GPC weight average molecular weight. For the purposes of regulating molecular weight of the polymer being formed, suitable chain transfer agents include well known halo-organic compounds, such as, carbon tetrabromide and dibromodichloromethane; sulfur-containing compounds, such as, alkylthiols including ethanethiol, butanethiol, tert-butyl and ethyl mercaptoacetate, as well as aromatic thiols; or various other organic compounds having hydrogen atoms which are readily abstracted by free radicals during polymerization. Additional suitable chain transfer agents or ingredients include but are not limited to butyl mercaptopropionate; isooctylmercapto propionate; bromoform; bromotrichloromethane; carbon tetrachloride; alkyl mercaptans, such as, 1-dodecanthiol, tertiary-dodecyl mercaptan, octyl mercaptan, tetradecyl mercaptan, and hexadecyl mercaptan; alkyl thioglycolates, such as, butyl thioglycolate, isooctyl thioglycoate, and dodecyl thioglycolate; thioesters; or combinations thereof. Mercaptans are preferred.

When a dispersion of polymer particles is utilized, the polymer particle size is controlled by the amount of conventional surfactants added during the emulsion polymerization process.

Conventional surfactants may be used to stabilize the emulsion polymerization systems before, during, and after polymerization of monomers. These conventional surfactants will usually be present at levels of 0.1 percent to 6 percent by weight based on the weight of total monomer. At least one anionic, nonionic, or amphoteric surfactant may be used, or mixtures thereof. Alternatively, all, or a portion, of the particle stabilization may be provided by initiator fragments, such as those of persulfates, when the fragments become incorporated into the polymer chain. Examples of anionic emulsifiers include sodium lauryl sulfate, sodium dodecyl benzene sulfonate, dioctylsulfosuccinate, sodium polyoxyethylene lauryl ether sulfate, sodium dodecyl diphenyloxide disulfonate and other diphenylsulfonate derivatives, and sodium slat of tert-octylphenoxyethoxypoly(39)ethoxyethyl sulfate. Examples of nonionic surfactants include glycerol aliphatic esters, oleic acid monoglyceride, polyoxyethylene aliphatic esters, polyoxyethylene glycol monostearate, polyoxyethylene cetyl ether, polyoxyethylene glycol monolaurate, polyoxyethylene glycol monooleate, polyoxyethylene glycol stearate, polyoxyethylene higher alcohol ethers, polyoxyethylene lauryl ether, polyoxyethylene nonylphenol ether, polyoxyethylene octylphenol ether, polyoxyethylene oleyl ether, polyoxyethylene stearyl ether, polyoxyethylenesorbitan aliphatic esters, polyoxyethylenesorbitan monolaurate, polyoxyethylenesorbitan monooleate, polyoxyethylenesorbitan monopalmitate, polyoxyethylenesorbitan monostearate, polyoxyethylenesorbitan trioleate, polyoxyethylenesorbitan tristearate, polyoxyethylenesorbitol tetraoleate, stearic acid monoglyceride, tert-octylphenoxyethylpoly(39)ethoxyethanol, nonylphenoxyethylpoly(40)ethoxyethanol.

Amphoteric surfactants may also be utilized solely, or in combination with anionic, nonionic, or mixtures thereof, to stabilize particles of the polymer during and after aqueous emulsion polymerization, or other dispersion polymerizations. For the purpose of stabilizing particles of polymer in aqueous systems, amphoteric surfactants may be used at levels of 0.1 percent to 6 percent by weight based on the weight of total monomer. Useful classes of amphoteric surfactant include aminocarboxylic acids, amphoteric imidazoline derivatives, betaines, and macromolecular amphoteric surfactants. Amphoteric surfactants from any of these classes may be further substituted with fluorocarbon substituents, siloxane substituents, or combinations thereof. Useful amphoteric surfactants can be found in Amphoteric Surfactants, ed. B. R. Bluestein and C. L. Hilton, Surfactant Series Vol. 12 Marcel Dekker NY, N.Y. (1982).

If desired the dispersed polymer may include multi-stage polymer particles having two or more phases of various geometric structures, such as for example, core/shell or core/sheath particles, core/shell particles with shell phases incompletely encapsulating the core, core/shell particles with a multiplicity of cores and interpenetrating network particles. In all of these cases, the majority of the surface area of the particle will be occupied by at least one outer phase and the interior of the polymer particle will be occupied by at least one inner phase. The outer phase of the multi-stage polymer particles weights 5 weight percent to 95 weight percent based on the total weight of the particle. It is often desirable for each stage of the multi-stage polymer particles to have a different Tg. If desired, each stage of these multi-stage polymer particles may be provided with different GPC number average molecular weight, such as, the multi-stage polymer particle composition disclosed in U.S. Pat. No. 4,916,171.

The multi-stage polymer particles of the dispersed polymer are prepared by conventional emulsion polymerization process in which at least two stages differing in composition are formed in a sequential fashion. Such a process usually results in the formation of at least two polymer compositions. Each of the stages of the multi-stage polymer particles may contain the same chain transfer agents, surfactants, as those disclosed earlier. The emulsion polymerization techniques used for preparing such multi-stage polymer particles are well known in the art and are disclosed, for example, in the U.S. Pat. Nos. 4,325,856, 4,654,397, 4814,373 and 4,916,171.

Any conventional zinc phosphate and calcium zinc phosphate can be used in the present invention. Zinc phosphate (ZnPh) is a white powder having a composition of ZnO/P2O5. Calcium zinc phosphate (CaZnPh) is a white powder having a composition of CaO/ZnO/P₂O₅. The particles having a diameter from 3 to 4 micrometers are preferably used. For example, the following commercially available products can be used in the present invention: LF Bousei P-W-2 supplied by Kikuchi Color Corp as zinc phosphate and LF Bousei CP-Z supplied by Kikuchi Color Corp. as calcium zinc phosphate. Zinc phosphate and/or calcium zinc phosphate is contained in the coating composition at about 10% pvc or less, preferably from about 0.1% to 0.5% pvc, more preferably from about 0.15 to about 1.0 pvc, and most preferably about 0.5 pvc. The abbreviation “pvc” means pigment volume concentration.

The composition of the present invention may further include a conventional white pigment, preferably, titanium dioxide, at concentrations in the rage of 5 to 20 percent, preferably 6 to 16 percent, all by weight percent based on the total weight of the composition. Some of the white pigments suitable for use in the present traffic paint include those supplied by E.I. du Pont and Company, Incorporated, Wilmington, Del. under the trade name as TiPure® titanium dioxide white pigment. Another supplier of titanium dioxide white pigment, under the trade name as TITAN™TR 92 Titanium dioxide, is Tioxide, Cleveland, United Kingdom.

If desired, the composition of the present invention may include 0.25% to 2% of a pigment dispersant based on the total weight of the polymer solid. Some of the suitable pigment dispersants include polymeric carboxylic acids, and ammonium and alkali metal salts thereof. Some of the suitable polymeric carboxylic acids include polyacrylic acid, polymethacrylic acid, copolymers of (meth)acrylic acid and maleic acid, all typically having a weight average molecular weight in the range of from 4000 to 10,000. Some of the other suitable pigment surfactants include copolymers of meth(acrylic) acid and polar compounds, such as, hydroxyethyl methacrylate, and non-polar compounds, such as, butyl methacrylate; and reaction products of maleic anhydride and diisobutylene. Polymethacrylic acid and ammonium and alkali metal salts thereof are preferred.

It is generally desirable to have additional components added to the coating composition to form the final formulation for traffic paints or other coatings described herein. These additional components include, but are not limited to, thickeners; rheology modifiers; dyes; sequestering agents; biocides; dispersants; pigments, such as, titanium dioxide, organic pigments, carbon black; extenders, such as calcium carbonate, talc, clays, silicas and silicates; fillers, such as glass or polymeric microspheres, quartz and sand; anti-freeze agents; plasticizers; adhesion promoters such as silanes; coalescents; wetting agents; surfactants; slip additives; crosslinking agents; defoamers; colorants; tackifiers; waxes; preservatives; freeze/thaw protectors; corrosion inhibitors; and anti-flocculants.

In the process for forming a road marking of the present invention, a road marking aqueous coating composition is applied to a surface of road. The coating composition can be applied on the surface of road by many methods known in the art, such as spraying. If desired, glass beads may be applied on top of the road marking, while the traffic paint is still wet, to produce reflective road marking having enhanced visibility.

The present invention will be explained in detail in the following examples. The examples are merely illustrative of the invention, and it is understood that the example does not restrict the scope of the invention.

### EXAMPLE 1

A coating composition was formulated by mixing the following materials. In this example, a difference of yellowing properties due to calcium carbonates was determined.

| Material | Parts by weight | |
|---|---|---|
| Binder Emulsion A | 570.0 | |
| Dispersant OROTAN 901 | 6.2 | |
| Wetting agent TRITON CF-10 | 3.4 | |
| Defoamer FORMASTER VL | 2.0 | |
| Titanium dioxide Ti-Pure R-902 | 120.0 | pvc 4.9% |
| Calcium carbonate | 885.0 | pvc 53.7% |
| Methanol | 33.5 | |
| Defoamer FORMASTER VL | 3.0 | |
| Coalescent TEXANOL | 28.5 | |
| Thickener HEC2% | 14.1 | |
| Water | 7.0 | |
| Solid percent by volume | 61.5% | |
| Solid percent by weight | 76.9% | |

NOTE) Fastrack 3427 (acrylic emulsion supplied by Rohm and Haas Company Philadelphia, Pa., 50% solid, molecular weight=50,000, particle size=150 nm) was used as Emulsion A.

OROTAN 901 is a dispersant (polyacrylacid ammonium salt) supplied by Rohm and Haas Company.

TRITON CF-10 is a wetting agent supplied by Union Carbide Chemical Inc., Danbury, Conn.

FORMASTER is a defoamer supplied by Henkel Corp.

Ti-Pure is titanium dioxide supplied by E.I. duPont De Nemours and Company. Wilmington, Del.

TEXANOL is an ester alcohol supplied by Eastman Chemical Co. Kingsport, Tenn.

Yellowing Test:

A binder polymer, dispersant, wetting agent and defoamer were mixed. Then titanium dioxide and calcium carbonate were added and mixed at 1000 rpm for 15 minutes. In the three compositions of example 2, 0.5 pvc of calcium carbonate was respectively substituted for by zinc oxide, zinc phosphate and calcium zinc, which phosphate was further added together with titanium dioxide and calcium carbonate. Then methanol, defoamer, and coalescent were further added and mixed. Finally, water and thickener were added to adjust viscosity and solid content.

The obtained coating composition was applied on black polyvinylchloride plate with 15 mil applicator and dried at room temperature for 2 days. A half portion of the plate having the dried coating layer was immerged in acidic rain or deionized water and held in sunny green house or dark place for 2 days. As the acidic rain, a solution of 10 L of 5% NaCl, 12 ml of conc. nitric acid and 17.3 ml of conc. sulfuric acid, of which pH was adjusted to 3 with 10% NaOH, was used. A color difference was determined by measuring L*/a*/b* of the plate at the immerged portion and non-immerged portion with MINISCAN (supplied by Hunter Associates Laboratory Inc.) and delta E was calculated. The result is shown in the following table.

| | | sunny/ | | |
|---|---|---|---|---|
| Coating No. | CaCO2 | acid rain | sunny/DIwater | dark/acid rain |
| 1 | A(Australia) | 7.0 | 3.8 | 1.0 |
| 2 | A(Korea) | 3.0 | 0.7 | 0.2 |
| 3 | B(Japan) | 0.9 | 0.3 | 0.5 |
| 4 | C(Japan) | 0.9 | 0.5 | 0.4 |

Calcium carbonate A is calcium carbonate OMIYACARB 10 supplied by OMIYA Inc. Calcium carbonate B is calcium carbonate Super S supplied by Maruo Calcium Inc. Calcium carbonate C is calcium carbonate Whiton B supplied by Shiraishi Calcium Inc.

The delta E below 1.0 is acceptable.

### EXAMPLE 2

Three coating compositions were prepared according to the procedure in Example 1, except that 0.5 pvc of calcium carbonate was replaced with zinc oxide (ZnO), zinc phosphate (ZnPh) and calcium zinc phosphate (CaZnPh), respectively. Calcium carbonate A(Korea), that shows yellowing, was used as calcium carbonate. The coatings were examined for stability, a degree of yellowing and drying rate.

Sangou Aenka supplied by Hakusui Kagaku Corp. was used as ZnO. LF Bousei P-W-2 supplied by Kikuchi Color Corp. was used as zinc phosphate. LF Bousei CP-Z supplied by Kikuchi Color Corp. was used as calcium zinc phosphate. The zinc phosphate comprises 65-70% of zinc oxide and 22% of P₂O₅ and the remaining was water of crystallization etc. The calcium zinc phosphate comprises 17% of CaO, 40% of zinc oxide and 21% of P₂O₅ and the remaining was water of crystallization etc.

A method of stability test and drying rate test were conducted as follows.

Stability Test: An initial viscosity of the composition and the viscosity after the storage at 60 C. for 10 days were measured. The viscosity was measured with Stormer viscometer as KU. In example 4, the viscosity after the storage at room temperature for 10 days was shown as an equilibrium viscosity

Drying Rate Test: A coating composition was applied on glass plate at a thickness of 375 micrometer with an applicator. The time to tack free was measured at 23 C./73% RH.

Stability test

| | | | viscosity (KU) |
|---|---|---|---|
| Coating No. | zincic pigment | initial | after heating (60 C., 10 days) |
| 2 | none | 80 | 85 |
| 5 | CaZnPh | 86 | 89 |
| 6 | ZnPh | 97 | 102 soft precipitation |
| 7 | ZnO | 90 | gel |

Yellowing Test

| Coating No. | zincic pigment | Delta E (sunny/acid rain) |
|---|---|---|
| 2 | none | 2.6 |
| 5 | CaZnPh | 0.7 |
| 6 | ZnPh | 0.7 |
| 7 | ZnO | 0.8 |

Drying time

| Coating No. | zincic pigment | Drying time (min.) |
|---|---|---|
| 2 | none | 16 |
| 5 | CaZnPh | 8 |
| 6 | ZnPh | 8 |
| 7 | ZnO | 8 |

The above results reveal that a yellowing property and drying time can be improved by an addition of zinc oxide, zinc phosphate, and calcium zinc phosphate. However, zinc oxide renders the coating composition to gel with time. On the other hand, zinc phosphate and calcium zinc phosphate caused no adverse effect on the stability of the coating composition. Calcium zinc phosphate provided the best result.

### EXAMPLE 3

The color difference and drying time were measured at several amounts of calcium zinc phosphate according to the formulation in example 2.

| Coating No. | PVC % of CaZnPh | Delta E | Drying time (min.) |
|---|---|---|---|
| 1 | 0 | 2.8 | 16 |
| 8 | 0.15 | 1.4 | 14 |
| 9 | 0.30 | 0.5 | 10 |
| 5 | 0.50 | 0.4 | 8 |
| 10 | 1.00 | 0.4 | 8 |

The yellowing property and drying time are improved with an increase of calcium zinc phosphate until 0.5% pvc. However, when the amount of calcium zinc phosphate was increased to 1.0 pvc, the properties were not improved anymore. Accordingly, the most preferable amount of calcium zinc phosphate is considered 0.5% pvc.

### EXAMPLE 4

aN influence of calcium zinc phosphate to a stability and drying time of the coating composition was studied by employing a different binder polymer.

| | Composition | | Composition |
|---|---|---|---|
| | 11 | | 12 |
| Material | Parts by weight | | Parts by weight |
| Binder Emulsion B | 570.0 | | 570.0 |
| Dispersant OROTAN 901 | 6.2 | | 6.0 |
| Wetting agent TRITON | 4.5 | | 4.5 |
| X-405 | | | |
| Defoamer FORMASTER | 2.0 | | 2.0 |
| 8034 | | | |
| Titanium dioxide Ti-Pure | 148.0 | pvc 6.65% | 148.0 |
| R-902 | | | |
| Calcium carbonate C | 706.0 | pvc 47.0% | 700.0 |
| CaZnPh | 0.0 | | 8.0 |
| Methanol | 15.0 | | 15.0 |
| Defoamer FORMASTER | 3.0 | | 3.0 |
| 8034 | | | |
| Coalescent TEXANOL | 59.0 | | 59.0 |
| Water | 30.0 | | 28.2 |
| Aqueous ammonia (28%) | 0 | | 1.9 |
| Solid percent by volume | 57.8% | | 57.8% |
| Solid percent by weight | 74.2% | | 74.2% |

NOTE) Fastrack 53 (acrylic emulsion available from Rohm and Haas Company, 51% solid, molecular weight=50,000, particle size=150nm) was used as Emulsion B.

| Coating | Drying time (min.) | | viscosity KU after |
|---|---|---|---|
| No. | tack free | equillibrium | heating (60 C., 10 days) |
| 11 | 40 | 93 | 99 |
| 12 | 14 | 94 | 96 |

The coating composition 12 that comprises calcium zinc phosphate has an improved drying rate. A stability of the coating composition was not affected by the addition of calcium zinc phosphate.

1. A fast-drying aqueous coating composition comprising a binder polymer and at least one pigment selected from the group consisting of zinc phosphate and calcium zinc phosphate.

2. The coating composition of claim 1 wherein the pigment is calcium zinc phosphate.

3. The coating composition of claim 1 wherein the coating composition is a road marking aqueous coating composition.

4. A coating layer obtained by drying the composition of claim 1.

5. A method for forming a road marking comprising to apply the aqueous coating composition of claim 1 to a surface of road.
